(19) United States
(12) Patent Application Publication
(10) Pub. No.: US 2015/0175107 A1
(43) Pub. Date: Jun. 25, 2015

(54) BACK BEAM FOR VEHICLE

(71) Applicants: Hyundai Motor Company, Seoul (KR); LG Hausys, Ltd., Seoul (KR)

(72) Inventors: Jin Young Yoon, Gimpo-si (KR); Seung Mok Lee, Osan-si (KR); Seung Hyeob Lee, Ansan-si (KR); Yong Kil Kil, Cheongju-si (KR); Kang Hyun Song, Anyang-si (KR); Hee June Kim, Daejeon (KR); Tae Hwa Lee, Gwangmyeong-si (KR)

(73) Assignees: Hyundai Motor Company, Seoul (KR); LG Hausys, Ltd., Seoul (KR)

(21) Appl. No.: 14/459,232

(22) Filed: Aug. 13, 2014

(30) Foreign Application Priority Data
Dec. 19, 2013 (KR) 10-2013-0159548

(51) Int. Cl. B60R 19/03; B60R 19/18

(52) U.S. Cl. CPC B60R 19/03; B60R 19/18; B60R 2019/1853

(57) ABSTRACT

A back beam for a vehicle may include a frame made of high-strength plastic composite containing fiber, and a cover injection-molded with the frame inserted to cover an outer side of the frame.

### CROSS-REFERENCE TO RELATED APPLICATION

The present application claims priority to Korean Patent Application No. 10-2013-0159548 filed on Dec. 19, 2013, the entire contents of which is incorporated herein for all purposes by this reference.

### BACKGROUND OF THE INVENTION

1. Field of the Invention

The present invention relates to a back beam for a vehicle which can secure formability and improve interface bonding force between hybrid materials.

2. Description of Related Art

Back beams for bumpers are made of plastic and metal. Plastic back beams are classified into high-strength plastic composite back beams reinforced with glass fiber and carbon fiber and common plastic back beams not reinforced with fiber.

High-strength plastic composite back beams are usually manufactured by thermal pressing that uses high-strength/high-rigidity sheet type of intermediate material and require additional members to be assembled due to a limit in design of the parts, so that the manufacturing cost and weight increases and they are difficult to disassemble.

Common injection-molded plastic back beams are freely designed, so the manufacturing cost is considerably reduced, but they are available only for vehicles that require low collision resistance because the rigidity is not sufficient in comparison to high-strength plastic back beams.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a back beam for a vehicle which can secure formability and improve interface bonding force between hybrid materials.

In an exemplary embodiment of the present invention, a back beam for a vehicle may include a frame made of high-strength plastic composite containing fiber, and a cover injection-molded with the frame inserted to cover an outer side of the frame.

The frame is formed by stacking and bonding a long fiber material containing long fiber and a continuous fiber material containing continuous fiber.

The cover is disposed at a position where the long fiber material of the frame is in contact with the cover.

The frame is formed by the long fiber material positioned under the cover and a plurality of continuous fiber materials bonded in a plurality of layers under the long fiber material.

The fiber is any one or more of glass fiber, carbon fiber, or aramid fiber.

The cover is injection-molded in a shape covering front, top, and bottom of the frame from an outside thereof.

The frame is manufactured by pressing a plurality of long and continuous fiber materials with rolls, and stacking and then heating the long and continuous fiber materials.

The cover, which is injection-molded in a shape covering front, top, and bottom of the frame from an outside thereof, is injection-molded in a shape covering an inner side of the frame at a portion.

The frame is formed with the long fiber material of approximately 30% and the continuous fiber material of approximately 70%.

The long fiber material is completely enclosed by the cover and the continuous fiber material therebetween.

According to the back beam for a vehicle which has the structure described above, it is possible to improve the interface bonding force between hybrid materials simultaneously with securing formability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a back beam for a vehicle according to an exemplary embodiment of the present invention.

FIG. 2 is a detailed view of the back beam for a vehicle according to an exemplary embodiment of the present invention.

FIG. 3 is a view showing the cross-section of the frame in the back beam for a vehicle according to an exemplary embodiment of the present invention.

FIG. 4 is a cross-sectional view taken along line A-A from the back beam for a vehicle shown in FIG. 1.

FIG. 5A is a view showing a process of manufacturing a back beam for a vehicle according to an exemplary embodiment of the present invention.

FIG. 5B is a view showing a process of manufacturing a back beam for a vehicle according to an exemplary embodiment of the present invention.

FIG. 5C is a view showing a process of manufacturing a back beam for a vehicle according to an exemplary embodiment of the present invention.

FIG. 6A is a view showing a process of manufacturing a back beam for a vehicle according to an exemplary embodiment of the present invention.

FIG. 6B is a view showing a process of manufacturing a back beam for a vehicle according to an exemplary embodiment of the present invention.

FIG. 6C is a view showing a process of manufacturing a back beam for a vehicle according to an exemplary embodiment of the present invention.

FIG. 6D is a view showing a process of manufacturing a back beam for a vehicle according to an exemplary embodiment of the present invention.

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Embodiments of the present invention are described hereafter with reference to the accompanying drawings.

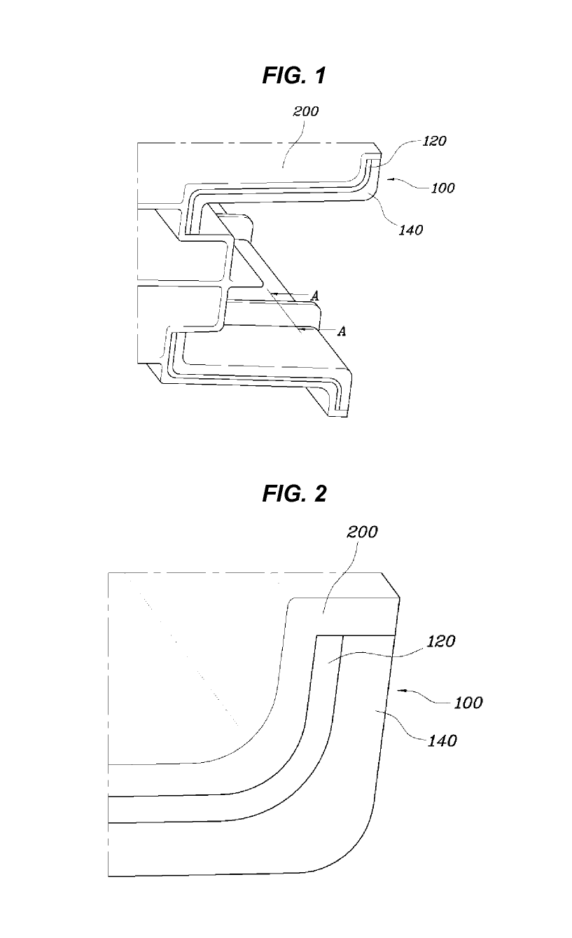

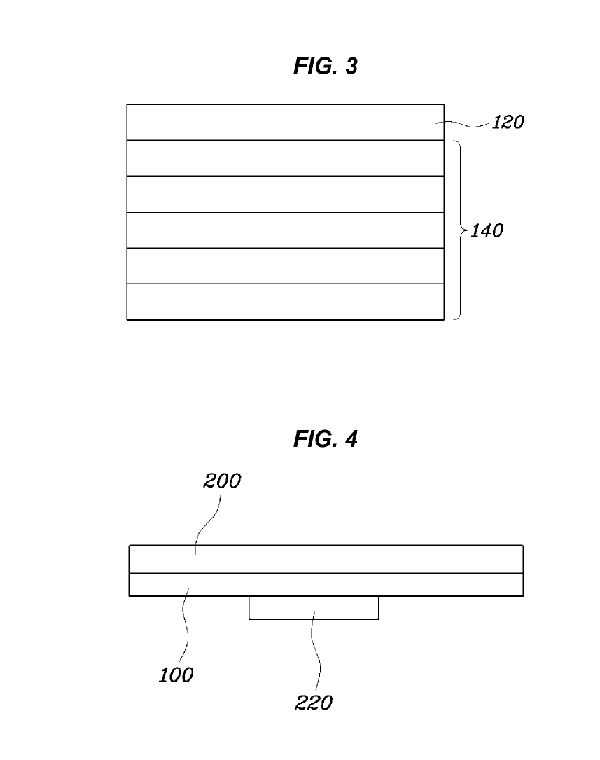

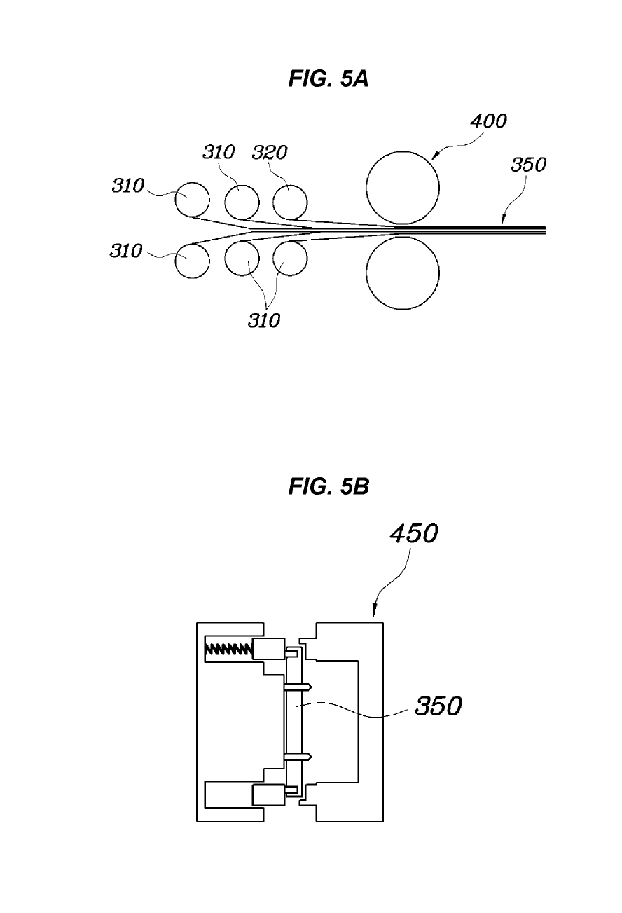

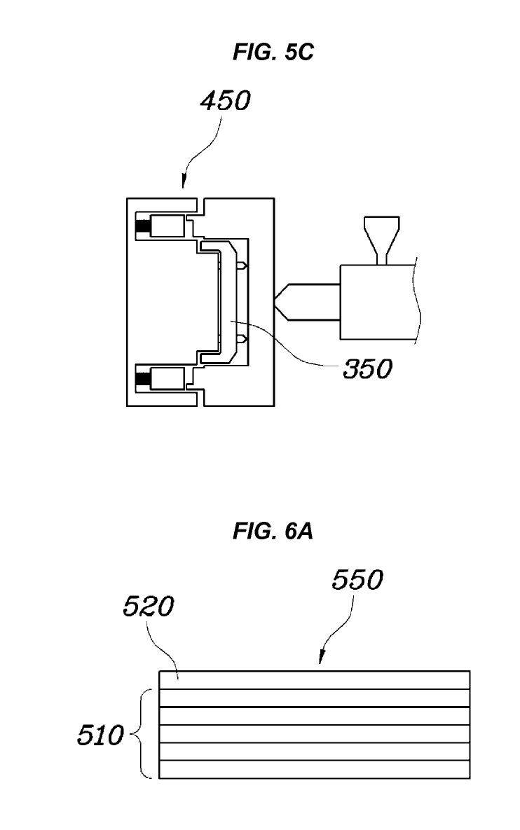

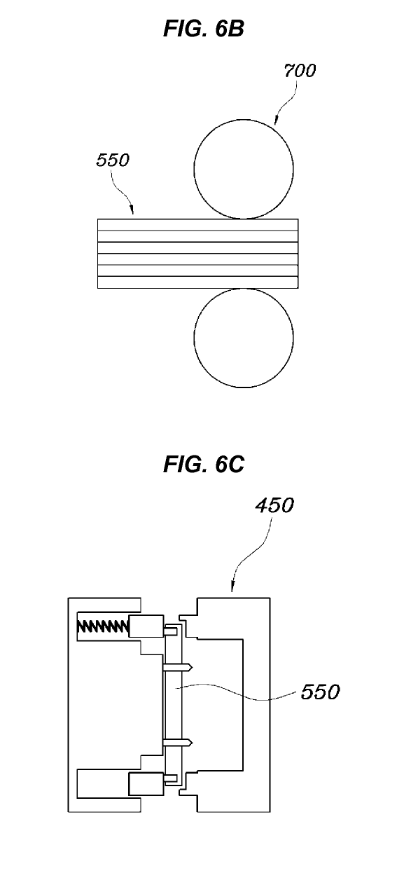

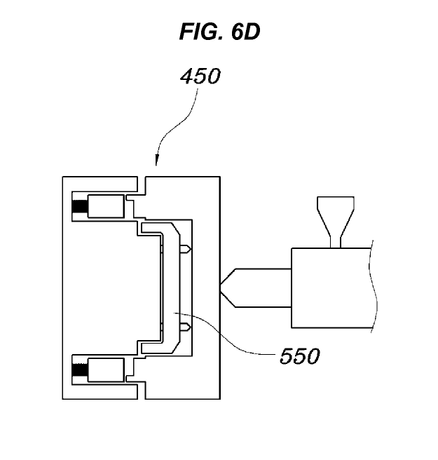

FIG. 1 is a perspective view of a back beam for a vehicle according to an exemplary embodiment of the present invention, FIG. 2 is a detailed view of the back beam for a vehicle according to an exemplary embodiment of the present invention, FIG. 3 is a view showing the cross-section of the frame in the back beam for a vehicle according to an exemplary embodiment of the present invention, FIG. 4 is a cross-sectional view taken along line A-A from the back beam for a vehicle shown in FIG. 1, and FIGS. 5 and 6 are views showing a process of manufacturing a back beam for a vehicle according to an exemplary embodiment of the present invention.

A back beam for a vehicle according to an exemplary embodiment of the present invention includes a frame 100 made of a high-strength plastic composite containing fiber and a cover 200 injection-molded with the frame 100 inserted to cover the outer side of the frame 100. That is, the back beam is made of different materials in a hybrid type, in which the main framework is formed by the frame and the cover is formed by a cover member.

In detail, the back beam is injection-molded with high-strength plastic inserted herein and the main factor related to the performance is the interface bonding force at the joint between the high-strength plastic and common plastic for injection molding.

As in FIG. 2, the frame 100 may be formed by stacking and bonding a long fiber member 120 containing long fiber and a continuous fiber member 140 containing continuous fiber.

In an exemplary embodiment of the present invention, the cover 200 and the continuous fiber material 140 completely encloses the long fiber material 120 therebetween.

Typical high-strength plastic is a long fiber composite material containing a mixture of long fiber and resin or a continuous fiber composite material containing a mixture of continuous fiber and resin. The continuous fiber composite material has higher strength than the long fiber composite material and the long fiber composite material is more freely formed (designed) than the continuous fiber composite material, so a hybrid composite material composed of continuous fiber and long fiber is used.

Using a hybrid composite material is for increasing the interface bonding force between common plastic and high-strength plastic, and the high-strength plastic used in an exemplary embodiment of the present invention includes a continuous fiber composite material of 70% or more and a long fiber of about 30% and disposed at the joint with common plastic, so that it increases the bonding force between materials. Accordingly, the frame may be disposed at the joint of the long fiber material and the cover, as in FIGS. 1 and 2.

The frame may be, as shown in FIG. 3, composed of a long fiber material 120 at the top and a plurality of continuous fiber materials 140 stacked in a plurality of layers under the long fiber material 120. The fiber may be any one or more of glass fiber, carbon fiber, or aramid fiber.

The surface of the high-strength plastic which is in contact with the common plastic is formed by a long fiber layer in the way of making one side of a long fiber layer when the high-strength plastic fabric is made.

The cover 200 may be injection-molded in a shape covering the front, top, and bottom of the frame 100 from the outside, as in FIG. 1. In particular, the cover 200, which is injection-molded in a shape covering the front, top, and bottom of the frame 100 from the outside, may be injection-molded in a shape covering the inner side of the frame 100 at a portion 220.

It is advantageous for the performance of a back beam with high-strength plastic inserted which is manufactured by injection molding to dispose high-strength plastic inside common plastic when making the bonding surface between the materials of the back beam. In particular, it is advantageous to cover the entire surface of a portion of the high-strength plastic with common plastic rather than to dispose the entire high-strength plastic inside the common plastic, in which an effect can be achieved when the covering surface has a width of 5 mm or more and a thickness of 2 mm or more.

As shown in FIGS. 5A to 5C and FIGS. 6A to 6D, the frame may be manufactured by pressing a plurality of fiber materials with rolls, and stacking and then heating them.

That is, as in FIGS. 5A-5C, one of the ways of making a high-strength plastic layer in a back beam is to prepare continuous fiber fabric rolls 310 and a long fiber fabric roll 320, form one fabric 350 with continuous fiber fabrics and a long fiber fabric bonded, by passing the fabric 350 through a press 400 like a double belt press and/or a multistage press (5A), heat the fabric 350 in an oven, put the fabric 350 into a mold 450 (5B), and then injecting and molding a backbeam with a high-strength plastic layer (5C).

Another way of making a high-strength plastic layer in a back beam is, as shown in FIGS. 6A-6D, to stack and heat continuous fiber fabrics 510 and a long fiber fabric 520 in an oven (FIG. 6A), put the stacked fabrics 550 into a mold 450 (FIG. 6C), and then injecting and molding a backbeam with a high-strength plastic layer (FIG. 6D) (but, it may be possible to increase the bonding force between the stacked fabrics 550 by pressing the fabrics with a press 700, as in FIG. 6B, before putting the fabrics into the mold 450).

According to the back beam for a vehicle which has the structure described above, it is possible to improve the interface bonding force between hybrid materials simultaneously with securing formability.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A back beam for a vehicle, comprising:
a frame made of high-strength plastic composite containing fiber; and
a cover injection-molded with the frame inserted to cover an outer side of the frame.

2. The back beam of claim 1, wherein the frame is formed by stacking and bonding a long fiber material containing long fiber and a continuous fiber material containing continuous fiber.

3. The back beam of claim 2, wherein the cover is disposed at a position where the long fiber material of the frame is in contact with the cover.

4. The back beam of claim 2, wherein the frame is formed by the long fiber material positioned under the cover and a plurality of continuous fiber materials bonded in a plurality of layers under the long fiber material.

5. The back beam of claim 1, wherein the fiber is any one or more of glass fiber, carbon fiber, or aramid fiber.

6. The back beam of claim 1, wherein the cover is injection-molded in a shape covering front, top, and bottom of the frame from an outside thereof.

7. The back beam of claim 2, wherein the frame is manufactured by pressing a plurality of long and continuous fiber materials with rolls, and stacking and then heating the long and continuous fiber materials.

8. The back beam of claim 1, wherein the cover, which is injection-molded in a shape covering front, top, and bottom of the frame from an outside thereof, is injection-molded in a shape covering an inner side of the frame at a portion.

9. The back beam of claim 2, wherein the frame is formed with the long fiber material of approximately 30% and the continuous fiber material of approximately 70%.

10. The back beam of claim 2, wherein the long fiber material is completely enclosed by the cover and the continuous fiber material therebetween.
